(19) United States
(12) Patent Application Publication
(10) Pub. No.: US 2013/0268479 A1
(43) Pub. Date: Oct. 10, 2013

(54) SYSTEM AND METHOD FOR PRESENTING AND MANAGING SOCIAL MEDIA

(71) Applicant: MYSPACE LLC, Beverly Hills, CA (US)

(72) Inventors: Michael Scott Andler, Los Angeles, CA (US); James Andrew Beaupre, Los Angeles, CA (US); Eric J. Kim, Tujunga, CA (US); Thomas B. Werz, III, Los Angeles, CA (US)

(73) Assignee: MYSPACE LLC, Beverly Hills, CA (US)

(21) Appl. No.: 13/858,857

(22) Filed: Apr. 8, 2013

Related U.S. Application Data
(60) Provisional application No. 61/621,057, filed on Apr. 6, 2012.

(51) Int. Cl. G06F 17/30

(52) U.S. Cl. CPC G06F 17/30563
USPC 707/602

(57) ABSTRACT

A method, system, apparatus, and computer program product provide the ability to present media content on a social media network. Live streaming data is received from multiple data sources. The data is enriched with meta information using internal systems via application programming interfaces (APIs). The live streamed data is transformed and transmitted, based on the meta information, to one or more users on a social media network.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/621,057 filed on Apr. 6, 2012, entitled “System and Method for Presenting and Managing Social Media” by Mike Andler, James Andrew Beaupre, Eric Juhyun Kim, and Thomas Barraud Werz III, attorneys' docket number 257.40-US-P1;

This application is related to the following co-pending and commonly-assigned patent application(s), which is/are incorporated by reference herein:

U.S. patent application Ser. No. 13/528,368 filed on Jun. 20, 2012, entitled “System and Method for Determining the Relative Ranking of a Network Resource” by Thomas B. Werz III, James Beaupre, and Eric J. Kim, attorneys' docket number 257.33-US-U1, which application claims the benefit of U.S. Provisional Patent Application Ser. No. 61/498,666, filed on Jun. 20, 2011, by Thomas B. Werz III, James A. Beaupre, and Eric J. Kim, entitled “System and Method Determining the Relative Ranking of a Network Resource in a Distributed Environment”,” attorneys' docket number 257.33-US-P1;

U.S. patent application Ser. No. 13/528,679, filed on Jun. 20, 2012, by Thomas B. Werz III, James A. Beaupre, and Eric J. Kim, entitled “System and Method of Tracking User Interaction with Content”, attorneys' docket number 257.39-US-U1, which application claims the benefit of U.S. Provisional Application Ser. No. 61/498,674, filed on Jun. 20, 2011, by Thomas B. Werz III, James A. Beaupre, and Eric J. Kim, entitled “System and Method of Tracking User Interaction with Content”, attorneys' docket number 257.39-US-P1;

U.S. patent application Ser. No. 13/858,720, filed on Apr. 8, 2013, by Michael Scott Andler, James A. Beaupre, Eric J. Kim, and Thomas B. Werz III, entitled “System and Method for Determining User or Resource Influence within a Pre-Defined Context”, attorneys' docket number 257.43-US-U1, which application claims the benefit of U.S. Provisional Application Ser. No. 61/621,051, filed on Apr. 6, 2012, by Mike Andler, James Andrew Beaupre, Eric Juhyun Kim, and Thomas Barraud Werz III, entitled “System and Method for Determining User or Resource Influence within a Pre-Defined Context”, attorneys' docket number 257.43-US-P1; and

U.S. patent application Ser. No. ______, filed on Apr. 8, 2013, by Michael Scott Andler, James A. Beaupre, Eric J. Kim, and Thomas B. Werz III, entitled “System and Method for Recommending Content”, attorneys' docket number 257.44-US-U1, which application claims the benefit of U.S. Provisional Application Ser. No. 61/621,049, filed on Apr. 6, 2012, by Mike Andler, James Andrew Beaupre, Eric Juhyun Kim, and Thomas Barraud Werz III, entitled “System and Method for Recommending Content”, attorneys' docket number 257.44-US-P1.

U.S. patent application Ser. No. 13/786,173, filed on Mar. 5, 2013, by Jason J. A. Knapp, entitled “User and Content Recommendation and Discovery Application”, attorneys' docket number 257.8-US-U1, which application claims the benefit of U.S. Patent Application Ser. No. 61/606,869, entitled “User and Content Recommendation and Discovery Application”, by Jason J. A. Knapp, filed on Mar. 5, 2012, Attorney Docket No. 257.8-US-P1.

### BACKGROUND OF THE INVENTION

1. Field of the Invention

This invention relates generally to methods and systems for presenting and managing social media. Exemplary embodiments affect content presentation and management according to a frame score, fan score, tag inheritance, viral influence, distributed statistical rankings and real time trending, among others.

2. Description of the Related Art

In the prior art, systems and methods of presenting and managing content rely upon basic tracking of user activities, e.g., to recommend content or in an attempt to otherwise engage the social media user. While such mechanisms may be somewhat effective, they still often present users with stale, less relevant or unwanted content. Further, such mechanisms do not more accurately and effectively engage the social media user to further encourage content interaction and user participation in the social media experience.

Accordingly, there is a need in the art for improved systems and methods for presenting and managing social media content.

### SUMMARY OF THE INVENTION

The above described and other problems and disadvantages of the prior art are overcome and alleviated by the present systems and methods for presenting and managing social media content. Exemplary embodiments utilize one or more of the following exemplary mechanisms.

One exemplary embodiment of presenting and managing social media utilizes a system and method for determining the relative ranking of a network resource on a network in a distributed environment, including generating data by measuring the activities of activities relative to a network resource on a network site, and processing such data as a distributed statistical ranking to provide real time rankings for the resource. In exemplary embodiments, a user's engagement score is utilized to create a percentile ranking against all or a subset of user's scores on a network using statistical models applied across the network in predefined intervals.

Exemplary embodiments generate data by calculating the virality of content on a network site. In such exemplary embodiments, an exemplary viral influence application may keep track of the history of how a piece of content was interacted with, e.g. by tracking user identity, content identity and previous users that interacted with content, or generate a list of users that previously interacted with content utilizing information including user identity, content identity, previous user information and an indication as to how far away a current interaction is relative to such previous users' interactions (e.g., by indicating the number of levels away). The relevant importance (score) of a user performing an action may also be taken into account.

In other exemplary embodiments related to viral influence data, the publishing service application may then use such a list of previous users to generate new information relative to each of such previous users indicating a current user's interaction with the content, identifying the previous user, indicating how far away the current interaction is relative to the previous user and indicating that the previous user did not directly perform the current interaction.

In other exemplary embodiments related to viral influence data, an exemplary engagement aggregator service application may then take each of the newly generated information from the publishing service application and aggregate such information at different levels of granularity, e.g. at a first level of content identity and engagement type and at a second level of user identity, content identity and engagement type. The exemplary engagement aggregator service application may also store such aggregations for a predetermined period of time before sending them to a storage service. Shorter time periods may allow for more real time results, but also require more processing resources.

In other exemplary embodiments related to viral influence data, an exemplary storage service application may store engagements (interactions) at various levels of granularity, e.g., at a first level of user identity, content identity, engagement type and number of levels away or at a second level of content identity, engagement type or number of levels away.

In other exemplary embodiments related to viral influence data, the exemplary storage service application may track the date and time that each engagement was saved to the storage device. In such a way, an exemplary embodiment may also provide a mechanism to aggregate engagements by time once they reach a predetermined age.

Other exemplary types of data that may be collected include how users interact with a network site, or how users interact with other users on the network site.

Some or all of the data obtained from the above or similar process may then be processed into a distributed statistical ranking to show real time rankings for viral influence or other appropriate category.

As will be described in more detail below, exemplary embodiments utilize statistical models, such as Standard Score, or Z-Score, Standard Deviation and/or Percentile Ranking models, to provide user percentile rankings against the rest of or a portion of a network site.

Another exemplary embodiment of the system and method for presenting and managing social media utilizes a system and method of recommending content to users by using plural recommendation scoring techniques. Some exemplary techniques compare content to previously consumed content by a user or other users associated with a user. In exemplary embodiments, such comparisons result in content recommendations for which users have a strong affinity. Exemplary processes for discovering relevant content include one or more of content characterization, tagging, relationship scoring and frame scoring, among others.

Exemplary embodiments herein can be configured to provide deeply accurate methods by which users of a content rich system can be introduced to relevant content from other sources, e.g., friends, acquaintances, like-minded users, nearby events, and celebrities, among others. By combining plural techniques of content assessment relative to a user, the expanded set of variables resultant therefrom can be used to greatly improve the accuracy of matches.

In further exemplary embodiments, any of the plural processes may include weighted scores as desired to adjust the likelihood of recommendation. For example, frame scoring may include weighted scores for activities involving users or resources on a site that themselves have higher activity scores. In exemplary embodiments, these users or resources that have higher interactivity with other users or resources may be considered to have a higher frame score. Further weights may be applied to activities such that more famous users or resources affect the frame scores of other users or resources more than less famous users or resources. An influence score and/or fan score may additionally be contributing factors to the weighting of recommendations. In exemplary embodiments, not all users will have frame, but they may have influence and fan scores (and vice versa).

In exemplary embodiments, similar effects can be constructed within, e.g., relationship scoring, where users more tightly affiliated with a particular user affect content recommendation scoring more than other users that are less tightly affiliated with that user.

Further, the relative effectiveness of each of the plural processes can be weighted as desired, e.g., where frame scoring is weighted to affect recommendations more than content characterization.

Another exemplary embodiment of the present system and method for presenting and managing social media utilizes a system and method of determining the influence of a user or resource within a pre-defined context. In exemplary embodiments, systems and methods described herein assign point values to all activities that may occur within that pre-defined context. In exemplary embodiments, the systems and methods are thus used to determine a user's or resource's global popularity, relevance, and/or desirability based on activities it is or has been associated with.

In further exemplary embodiments, such determinations may be made over discrete time intervals or in real time across all activities associated with the user or resource. In other exemplary embodiments, such determinations may be made in category specific contexts, including but not limited to a social networking site, point based contests, promotions, games and marketing, among other examples.

In other exemplary embodiments, the systems and methods provide weighted scores for users or resources, such that activities associated with higher scored users or resources affect other users or resources more significantly than lower rated users or resources. Exemplary embodiments also provide awards to higher scored users or resources, for example by way of increased usage opportunity, marketing advantages, feature targeting and higher visibility to the masses, among others.

In another exemplary embodiment, such systems and methods provide a frame score for a user or resource on a social networking site by assigning such point values to all activities on the social networking site. As in other exemplary embodiments, an exemplary weighted scoring may be utilized to allow more famous users or resources to affect the scores of other users or resources more significantly than less famous users or resources, thus rewarding the importance of celebrity influence and organic global reach.

The above discussed and other features and advantages of the present invention will be appreciated and understood by those skilled in the art from the following detailed description and drawings.

### BRIEF DESCRIPTION OF THE DRAWINGS

Referring now to the drawings in which like reference numbers represent corresponding parts throughout:

FIG. 1 illustrates a plot of user scores for any given engagement value against the normal distribution of the population in accordance with one or more embodiments of the invention;

FIG. 2 illustrates the logical flow for determining the relative ranking of a network resource on a network in a distributed environment in accordance with one or more embodiments of the invention;

FIG. 3 illustrates a general exemplary system schematic that shows how user interaction with content may provide data to a viral influence service (or application) in accordance with one or more embodiments of the invention;

FIG. 4 illustrates an exemplary flowchart tracking overall shares of a song between users, as well as an indication as to how far away a current interaction is from previous user interactions in accordance with one or more embodiments of the invention;

FIG. 5 illustrates the logical flow for tracking user interaction with content in accordance with one or more embodiments of the invention;

FIG. 6 illustrates an exemplary method of determining the influence of a user or resource within a pre-defined context in accordance with one or more embodiments of the invention;

FIG. 7 illustrates an exemplary system architecture utilizing plural subsystems to present and manage social media in accordance with one or more embodiments of the invention;

FIG. 8 illustrates an exemplary relationship between plural subsystems in the context of the system architecture in accordance with one or more embodiments of the invention;

FIG. 9 is an exemplary hardware and software environment used to implement one or more embodiments of the invention; and

FIG. 10 schematically illustrates a typical distributed computer system using a network to connect client computers to server computers in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Embodiments of the invention include systems and methods for presenting and managing social media that utilize one or more of various subsystems. Exemplary subsystems will be described in turn, followed by a discussion of their context in the system architecture and a discussion of system and method flow.

Distributed Statistical Ranking (A System and Method of Determining the Relative Ranking of a Network Resource on a Network in a Distributed Environment) and Viral Influence (A System and Method of Tracking User Interaction with Content)

As was noted above, the present disclosure relates to various exemplary systems and methods directed to the presentation and management of social media. One exemplary embodiment includes a system and method for determining the relative ranking of a user or user's content on a network in a distributed environment;

Such embodiments may also include and rely upon systems and methods for tracking user interaction with content (e.g., also referred to as Viral Influence), including communicating to a publishing service application upon user interaction with content, an identity of a user, an identity of content interacted with, an engagement type and an identity of a previous user who interacted with the same content. In exemplary embodiments, such a publishing service may then determine whether the interaction could potentially cause other users to further interact with the content and, if so, communicate this to a viral influence application. Data obtained from the above may then be processed into a distributed statistical ranking to show real time rankings for viral influence, among other things.

### Distributed Statistical Rankings

After collecting real-time data about how users interact with each other and with content, the data can be input into a distributed statistical ranking to show real-time rankings for the data (e.g., with respect to viral influence or another appropriate category).

Embodiments of the invention utilize statistical models, such as Standard Score, or Z-Score, Standard Deviation and/or Percentile Ranking models, to provide user percentile rankings against the rest of, or a portion of, a network site.

Engagement Score

As used herein, a user's engagement score identifies a user's level of engagement/interaction with another user, website, resource, etc. An engagement score may be categorized by the type of engagement. Further, the level of engagement/interaction may be determined using a variety of mechanisms/methodologies. To enable the engagement score to have some meaning, various different methods may be used to place the engagement score into the appropriate context.

Scoring Engagement Types Against Population

To add context/meaning to a user's engagement score, a user may be provided with a percentile ranking against some or all of a network site (e.g., social media). To provide such a context/comparison with respect to a network site, statistical models may be used, e.g., Standard Score/Z-Score, Standard Deviation, and Percentile Ranking

In one or more embodiments, the standard deviation and mean are calculated across a network site at regular intervals. This interval may be any desired interval and/or defined time period, e.g., on the order of minutes, hourly, across multiple hours, etc. The degree of near real-time performance may be balanced against performance as desired.

The calculation of the Standard Deviation and Mean will create the Normal Distribution, which a user's engagement value/score can be plotted against. As the user's value/score increases, so will the user's position on the curve.

A level of inaccuracy may be introduced as the interval between the calculations of the standard deviation and mean increases. Such an inaccuracy results because other user's values are changing independently from the curve. Once the curve is re-calculated, the users' positions may be adjusted. Nonetheless, the inaccuracies between calculation cycles may be corrected using historical data (e.g., by using the historical data to determine or estimate projected user's engagement values/scores).

In addition to the above, the plot may also be utilized to illustrate a user's score with respect to a specific population/group of users. However, such a plot may be more complex and expensive to perform, thereby potentially reducing the frequency at which the value can be calculated and plotted.

Any resource type can be ranked against its peers, e.g., users, songs, videos, etc. A change in score may also be ranked over a period of time (delta over time). This measures the acceleration of a resource, for example, “The Top 20 Songs” will be a list of the most popular songs on a social media network (e.g., Myspace™), and might not change over the course of a week. However, the song that has changed the most over the last week will be the list of the up-and-coming songs, e.g., the songs that are currently trending, but don't have the overall top plays. These windows/periods of time can be varied: hourly, daily, weekly, etc.

Normal Distribution

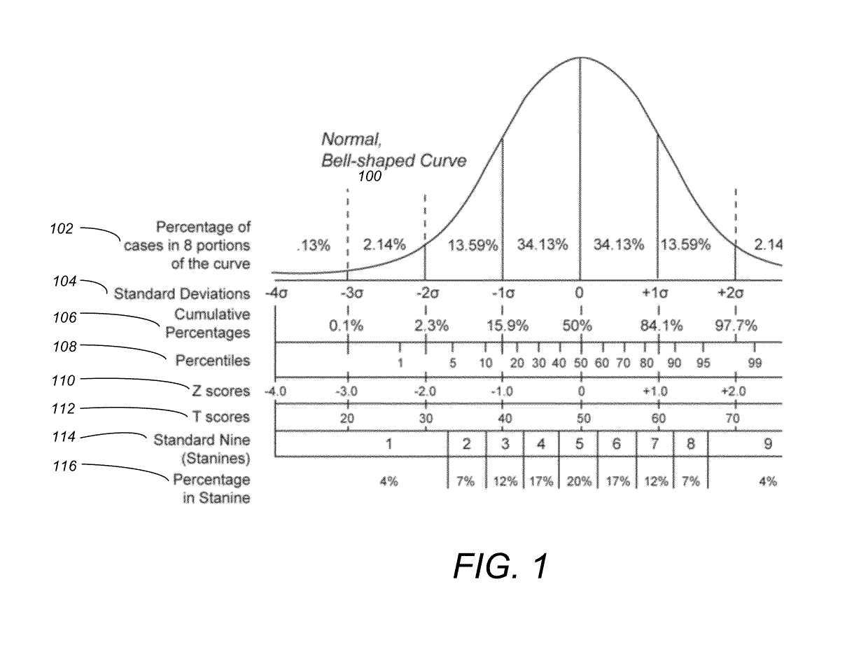

FIG. 1 illustrates a plot of user scores for any given engagement value against the normal distribution of the population. The normal distribution of the population is represented by the bell-shaped curve 100. The top most row 102 represents the percentage of cases/users in eight portions of the curve—13%, 2.14%, 13.59%, 34.13%, 34.13%, 13.59%, 2.14%, (the last portion is not shown). The second row 104 illustrates the standard deviations of the engagement scores from −4σ to +2σ. The third row 106 illustrates the cumulative percentages of the engagement scores. The fourth row 108 represents the percentiles of engagement scores. Based on the curves, a z-score 110 can be computed. The z-score 110 can be converted to a percentile, or, as illustrated in FIG. 1, any other value desired.

The mean of the population and standard deviation 104 define the curve 100. A simple formula can be applied to the user's value in real time to get the user's position on the curve 100. The curve 100 may also be updated by re-calculating the standard deviation 104 and mean on a regular interval.

Calculating Mean

The mean (i.e., average engagement score) of the population can be calculated in parallel on each profile database at the same time. This allows the system to scale the process, giving linear performance. Better performance means the ability to recalculate more frequently. The following equation can be used to calculate the mean x̅ (for an engagement score x with a population n)

$$\overline{x} = {\sum }_{j = 1}^{n} {x}_{j} / n$$

The mean may then be adjusted against the % of population on each database. For example: Myspace™ may have 800,000 users who are part of the calculation. The entire site has 100,000,000 users across all profiles involved in the calculation. The mean for Myspace™ would be multiplied by 0.008 (800000/100000000). This weighted average would be summed for each profile range to create the average mean for the site.

Calculating the Standard Deviation

The standard deviations 104 can be calculated in parallel by using the raw score method based on the following equation:

$${σ}^{2} = \frac{Σ {X}^{2} - \frac{{( Σ X )}^{2}}{N}}{N}$$

where σ is the standard deviation, S is the engagement score, and N is the total population.

In exemplary embodiments, the components of this calculation may be summed on each profile range. The summed values may be centralized to produce a global standard deviation to normally distribute user activity.

Using the Standard Deviation and Mean to Produce a User's Rank

In exemplary embodiments, generating the location of a value along the curve as defined by the standard deviation and mean may be performed using a standard score method. The standard score (also known as Z-Score 110) provides the position of a value along the curve. This Z-Score 110 can then be used to generate a user-facing ranking, or simply converted to a percentile.

$$z = \frac{x - μ}{σ}$$

where x is the engagement score, μ is the mean, and σ is the standard deviation.

### Exemplary Implementations of Distributed Statistical Ranking

The distributed statistical ranking described above can be utilized in/for a variety of different implementations. The descriptions below provide examples of some of these implementations.

User Relevance

The system may use action points or discovery points to calculate a user's percentile ranking relative to the other users on the site. The relative percentile ranking may be calculated over various time periods, such as one (1) day, seven (7) days, one (1) month, and all time. Further, the relative percentile ranking may be tracked over time to determine whether a user's ranking relative to other users has increased or decreased. If desired, a user's ranking may also be shown among their friends, as well as showing how this has changed over time.

Dashboard

The relative ranking for a user or any piece of content that they own can be displayed in a dashboard. Users may also be given an “at a glance” view of how they are doing relative to everyone else on a social network using charts and graphs, spider web charts, etc. (e.g., within a dashboard). As used herein, a dashboard refers to a toolbar, tool, application, and/or window that can be used to provide information or to select services/applications.

Levels for Reputation

One way to assign levels to a user is to just use their distributed rank. For instance, if a user is in the 58^{th} percentile, the user may be assigned to level 58. This will mean that a user's level will go down if the user stops interacting with the site, if people stop interacting with the user, etc.

Top User Influence

Top users may be permitted to influence the direction of a product/application (e.g., Myspace™). In this regard, once the distributed statistical ranking is obtained, top users on a social network, based on their relevance ranking (e.g., from the distributed statistical ranking or from another website/application that provides the ranking—e.g., the Wildfire™ application), may be allowed to have a direct line of communication with social network development teams. Users' suggestions may be used, e.g., to create a product backlog, which can be broken up vertically or handled all by one team. Thereafter, social networks may actually implement what users are asking for. A process may also be provided by which users can see that their suggestions are being heard (when an administrator reads them, responses from the administrator, etc.) so that users feel like their feedback is being used and that they are being heard.

Automated Suggestions

By analyzing (data mining) engagement trends over a large number of users, the system may determine which types of engagements are going to be the most valuable to a user for increasing a user's value, social/discovery points, or action points. Accordingly, automated suggestions will help users who are low in ranking determine what to do next, similar to what credit bureaus suggest people to do in order to increase credit scores.

Custom Support Priority Queue

Users who are ranked higher can be automatically prioritized in a support queue.

User Competitions

The system may also use user relevance scores to give prizes (could be a virtual badge for bragging rights or something physical) to the top users. Top users can be calculated over any time window.

Gifting Points

Points may be gifted to boost a user's relevance ranking. In exemplary embodiments, users with a large number of social points are allowed to “boost” other content by assigning extra points to it. The higher a user is ranked (social points) the more points the user may be allowed to give to other content on the site. Points may be provided via a channel (e.g., area of a website) for such users (referred to as taste makers) to temporarily increase the relevance and ranking of a band, a video, a song, a profile, or any other content on the site. Users can have a set number of points they can gift every 24 hours (rolling) that will recharge over time. In exemplary embodiments, points may not increase beyond the daily maximum for the user.

### Distributed Statistical Ranking Logical Flow

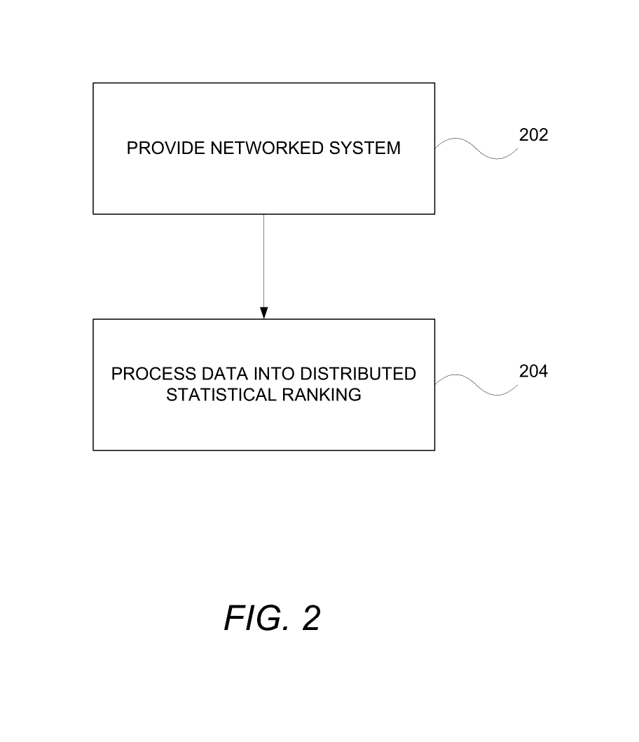

FIG. 2 illustrates the logical flow for determining the relative ranking of a network resource on a network in a distributed environment in accordance with one or more embodiments of the invention.

At step 202, a network system that is configured to recognize and collect data representative of activities regarding network resources on a network site is provided. Such network resources may include users, user content, songs, videos, or other content located on the network site. The data may represent how a user interacts with some or all of the network site, how a network resource is interacted with by a user, and/or may include viral influence data (as described in further detail below).

At step 204, the data is processed into a distributed statistical ranking to show real time resource rankings relative (e.g., determined at regular defined intervals) to a predefined subset of the network site. Such a ranking may indicate a user's ranking relative to other users, to a user's friends, or to one or more users over a period of time. Further, the processing may be via standard/z-score, standard deviation, or percentile ranking models to calculate a network resource percentile ranking against at least a portion of the network site. In this regard, the resource ranking may be a measurement of the standard deviation and mean (where the standard deviation and/or mean may be calculated in parallel on plural profile databases at the same time) of a network resource engagement score across a portion of the network site. The mean value may also be adjusted against a percentage of population on each database while the standard deviation calculation may be used to produce a global standard deviation. The network resource percentile ranking may be calculated over a period of time (e.g., hourly, daily, weekly, or any other defined period of time [defined by the user or otherwise]) to show acceleration/deceleration of the resource.

As described herein, the resource ranking may also be used to assign a user level to a user. Such a level may then be used in further processing (e.g., to provide additional benefits to the user). In one or more embodiments, communications with network development, support or administrative personnel may be allowed or prioritized for a user with a particular real time resource ranking.

Steps 202 and 204 may include multiple components that perform various activities as described in further detail below. For example, at step 202, the networked system may also be configured to recognize an engagement of content by a user. Data related to the content may be communicated to a publishing service application. The data can include an identity of a user, an identity of content interacted with, an engagement type, and the identity of the previous user who directly influenced the content interaction. The publishing service (which is part of the networked system and performs the processing at step 204) determines a likelihood that the interaction will cause other users to further interact with the content. Upon a positive determination that interaction will cause further interaction, the positive determination (and other information) may be forwarded to a viral influence application.

The processing of the data 204 may also be used to present the data to a user (either a network user or an administrator that is using such data). For example, a network resource's engagement score may be plotted against a normal distribution derived from the standard deviation and mean such that when the engagement score increases, the resource's position on a plotted curve also increases. Historical data may also be used to correct inaccuracies in the plotted positions between calculation cycles. The data may be presented/displayed to a user/administrator in a user dashboard.

In response to a ranking and to encourage a user's interaction with a network site, recommendations may be provided to a user that would likely result in a boost to a user's relative ranking. To further encourage a user's interaction, prizes or awards may be provided to a user based on the user's relative ranking. In addition, an active user may be awarded virtual points that the active user can grant/award to other users and/or resources thereby increasing such a resource's (and/or user's) ranking (temporarily). Such points may be given to an active user on a periodic basis and/or points may partially recharge (e.g., from/to a maximum number of points) during or after such a period.

In view of the above, embodiments of the present invention provide simple, quick and efficient mechanisms for seeing how a user, photo, video, song, or any other resource on a network ranks relative to other content of the same type. Further embodiments allow this to be done in real or near-real time, so that as resources are interacted with (song plays, users profiles visits, video comments, etc.), the ranking of the resource will change. This accordingly alleviates the need to have to rely on expensive offline calculations in a data warehouse or expensive nightly aggregations of data. Also, by providing a flexible way to combine different counters in a formula, generating motile statistical rankings becomes a very inexpensive process.

Exemplary embodiments also advantageously boost performance by allowing processing data in parallel, which allows for the possibility of scaling indefinitely. In other exemplary embodiments, performance is also boosted by defining that each server will be responsible for its own calculation. Reducing the calculation from centralizing, e.g., 200 million records, then processing this giant dataset, exemplary embodiments have effectively distributed the calculation, whereby each node has to only deal with, e.g., ˜600K records. This will enable the system to perform the process more frequently.

Exemplary embodiments also advantageously boost accuracy by using a raw score method, which allows the system to perform all calculations needed in a single pass, whereas other methods require a global mean to be calculated first, then the variance of each record against that global mean. Exemplary embodiments also provide that the system doesn't have to perform sampling. Instead, the system can include the entire population in the calculation. Finally, exemplary embodiments provide that the system doesn't have to average each node's standard deviation, which would result in more inaccurate values.

### Viral Influence

The distributed statistical ranking described above provides the ability to visualize, measure, and/or depict a ranking of content on a social network in real time. The distributed statistical ranking places the engagement of the user (with content) into a context of the general population's engagement.

Closely related to distributed statistical ranking is the ability to track the virality of content on or outside of a social network in real time. Viral influence provides such a methodology. Viral influence provides users on a social network with a mechanism to observe how their actions of creating, sharing, and interacting with content affect how other users interact with the same content. The overall viral influence of a user is calculated in real time based on all of the content the user has interacted with. Virality also provides insight into how a particular piece of content has been interacted with, including who interacted with the content, who influenced interaction with the content, and when it happened. The virality of a piece of content is tracked for any number of users and up to any number of levels deep.

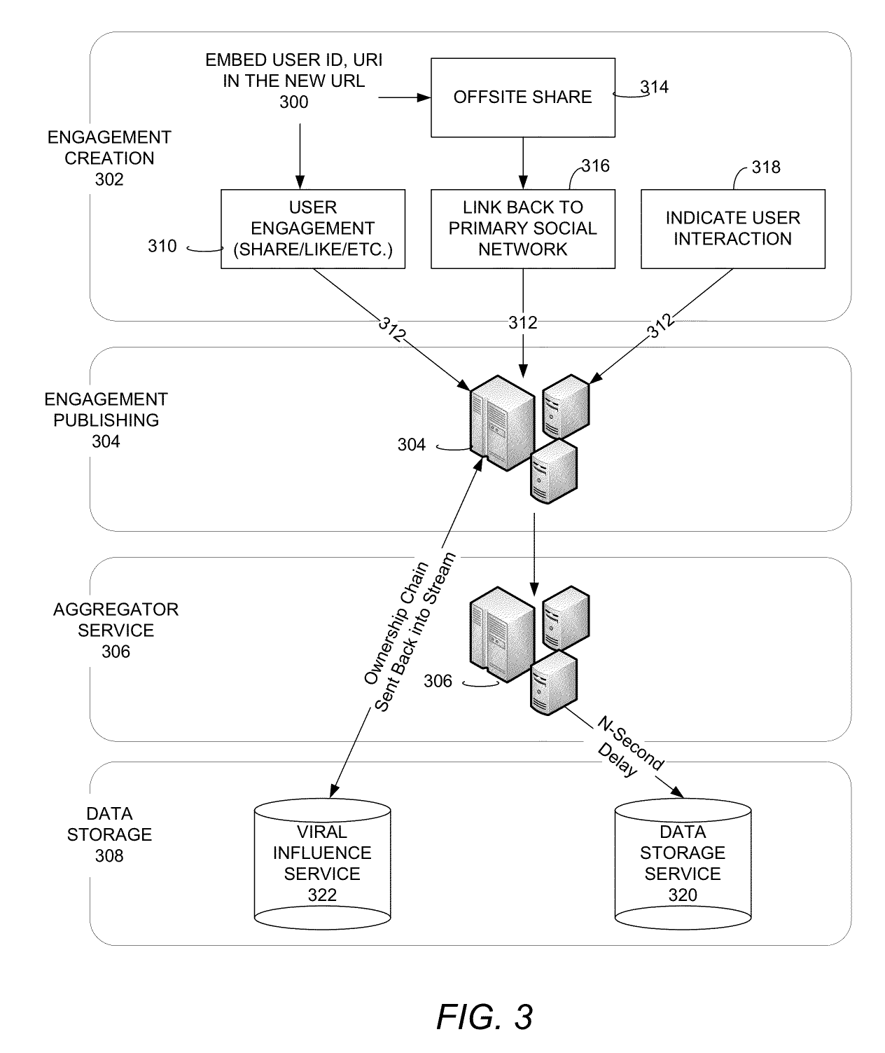

FIG. 3 illustrates a general exemplary system schematic that shows how user interaction with content may provide data to a viral influence service (or application) in accordance with one or more embodiments of the invention.

The first stage of the process is that of the creation of engagement 302 with content. Once created, the engagement is published at 304. The engagement content from multiple locations is aggregated using aggregator service 306 and stored in data storage at 308.

Viral influence begins with a piece of content that passes from one person to another. This typically happens when one person likes, shares, follows, plays, comments on, or in some way interacts with a piece of content. When this interaction is presented to the user's friends, they are more likely to interact with the content themselves and so on, which is one way for content to go “viral”.

Accordingly, an exemplary viral influence application may keep track of the history of how a piece of content was interacted with, e.g. by tracking the user identity, the content identity, and the previous users that interacted with the content. Alternatively, a viral influence application may generate a list of users that previously interacted with the content utilizing information including the user identity, the content identity, previous user information, and an indication as to how far away a current interaction is relative to such previous users' interactions (e.g., by indicating the number of levels away).

Referring again to FIG. 3, to track the virality of content, when the content is passed from one user to another, the user id for that user and/or the uniform resource identifier (URI) for the content may be embedded into a URL at 300. User interaction with such content may be initiated via a share of the content with another user, an indication that a user likes that content or some other form of interaction. Such a user interaction is referred to as an “engagement” 310.

An engagement message 312 is then sent to a publishing service 304. Other similar engagement messages 312 may similarly be generated, e.g., where content is shared to a secondary site 314 (e.g., a different social network or social communication mechanism such as Facebook™, Twitter™, etc.) and then linked back to a primary social network site 316. Alternatively, an external site may be configured to communicate with a primary site to recognize/indicate such user interaction 318. For example, a message may be “retweeted” or “reshared” on a primary or secondary (e.g., external) social network.

Accordingly, when a user interacts with a piece of content, the engagement message 312 is sent describing the interaction to a publishing service 304. The engagement message may contain:

a. User: The user (e.g., a user ID) who interacted with the resource;

b. Resource: The resource (e.g., a resource ID or URI) which was interacted with (a song, a video, a user, etc);

c. Engagement Type: The type of interaction (e.g., video play, song like, etc); and

d. Previous User: The previous person (e.g., a user ID) who interacted with the content and was thus the cause of this user interacting with it.

The publishing service application 304 may then use such a list of previous users to generate new information relative to each of such previous users indicating a current user's interaction with the content, identifying the previous user, indicating how far away the current interaction is relative to the previous user and indicating that the previous user did not directly perform the current interaction.

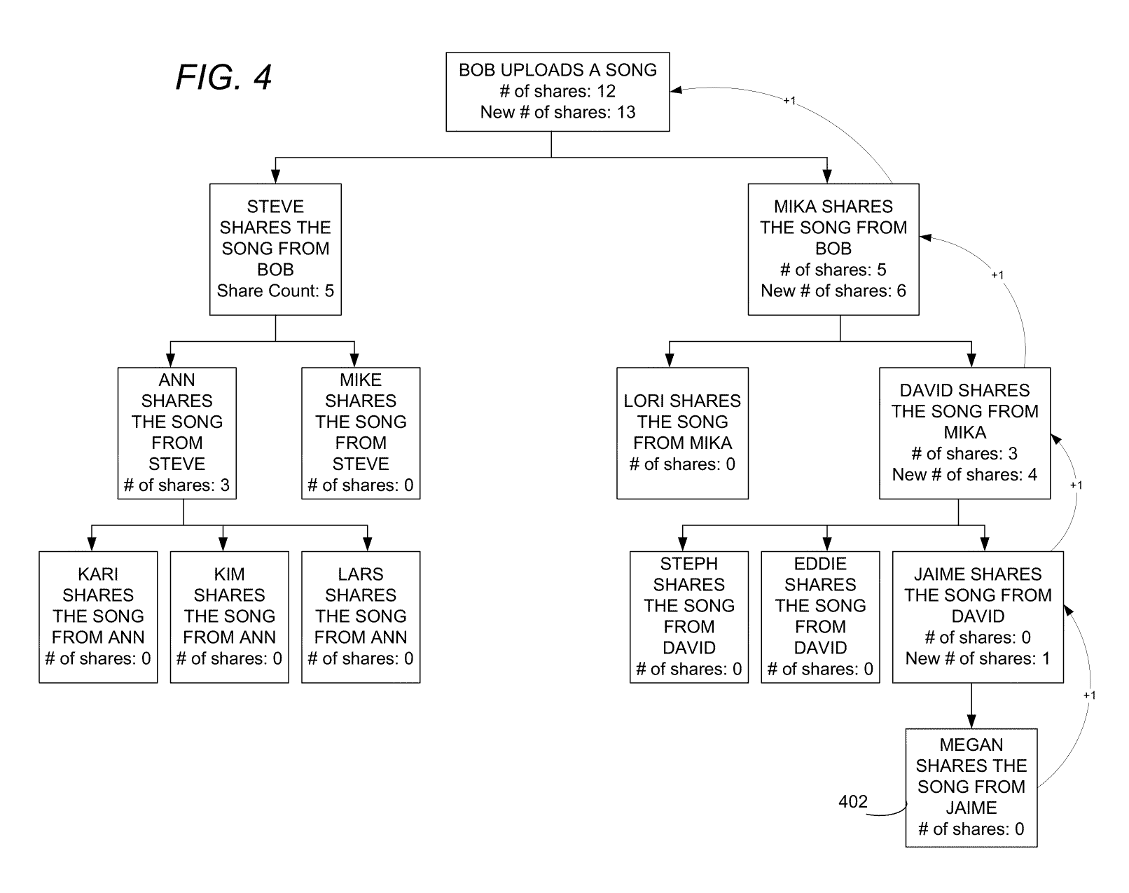

FIG. 4 illustrates an exemplary flowchart tracking overall shares of a song between users, as well as an indication as to how far away a current interaction (see box 402 in FIG. 4) is from previous user interactions. As illustrated in FIG. 4, Bob uploads a song and maintains an aggregated count regarding the number of shares and the number of new shares. Mika and Steve both shared the song from Bob (for a share count of 2). Ann and Mike then shared the song from Bob, with Kari, Kim, and Lars further sharing the song from Ann. Thus, on the left side of FIG. 4, a total of five (5) shares can be attributed to Bob (three for Kari, Kim, and Lars, one from Ann, and one from Mike) and all six (6) (including Steve) can be attributed to Bob. On the right side of FIG. 4, there is a total of seven (7) shares to provide Bob with a total of 13 shares (six via Steve, and seven via Mika). The “+1” arrows indicated additional levels of sharing that have occurred.

Returning to FIG. 3, the publishing service 304 has various options upon receipt of the engagement message 312. The publishing service 304 may inspect the message 312 to determine if the interaction could potentially cause other users to further interact with the content. If so, the message 312 is forwarded to the viral influence service 322. Alternatively, or in addition, the publishing service 304 may send the message to an engagement aggregator service 306 (this is merely exemplary but may be desired for scalability).

The engagement aggregator service application 306 may then take each of the newly generated information from the publishing service application 304 and aggregate such information at different levels of granularity, e.g. at a first level of content identity and engagement type and at a second level of user identity, content identity and engagement type. The exemplary engagement aggregator service application 306 may also store such aggregations for a predetermined period of time (i.e., an N-second delay) before sending them to a storage service 320. Shorter time periods may allow for more real time results, but also require more processing resources.

A storage service application 320 may store engagements (interactions) at various levels of granularity, e.g., at a first level of user identity, content identity, engagement type and number of levels away or at a second level of content identity, engagement type or number of levels away.

Additionally, the exemplary storage service application 320 may track the date and time that each engagement was saved to the storage device. In such a way, an exemplary embodiment may also provide a mechanism to aggregate engagements by time once they reach a predetermined age.

As described above, a viral influence service 322 may be configured to track the viral influence relative to ownership (engagement) chain data though a publishing service 304 and aggregator service 306 to determine the viral influence of content. Thus, the viral influence service 322 may provide one or more functions. As a first function, the viral influence service 322 may keep track of the history of how a piece of content was interacted with. Such a history may track at a minimum: the user, the resource, and the previous user.

In addition, the viral influence service 322 may return a list of people who previously interacted with the resource to the publishing service. Such a list may contain the user, the resource, the previous user, and/or the number of levels away (i.e., how far away this interaction was from the current person).

When the publishing service 304 receives a list of previous users from the viral influence service 322, the publishing service 304 may create a new engagement message 312 and forward the new engagement message 312 to an engagement aggregator service 306. The new engagement message 312 is created for each previous user in the list of previous users and may contain:
i. The same user, resource, and engagement as the original message;
ii. The previous user: from the list of previous users, one per message;
iii. NumLevels: How far away this interaction was from the current person. The previous user will always be one level away, the user before that two levels, etc. and
iv. A viral engagement flag: This indicates that the user did not directly perform the action, but that the action was performed indirectly as a result of something they did.

An engagement aggregator service 306 may optionally be included/utilized to improve scalability. Such an aggregator service 306 may be configured to multicast messages, aggregate at different levels of granularity, and store aggregations for a defined period of time. For aggregating at different levels of granularity, the aggregator service 306 may be required to perform aggregations at the following levels:
i. Resource, Engagement Type; and/or
ii. User, Resource, and Engagement Type.

After storing the aggregations for a defined/set period of time, aggregator service 306 may send the aggregations to a storage service 320. The period of time may be seconds, minutes, and/or can be configured. Shorter time periods provide more real time results but require more resources to process.

The storage service 320 may store engagements at several levels of granularity (including: (a) User, Resource, EngagementType, NumLevels; and/or (b) Resource, EngagementType, NumLevels), may track the date/time that each engagement was saved to the storage service, and/or may optionally provide a mechanism to aggregate engagements by time once they reach a predetermined age. For example, at the end of each day, all engagements for the same user, engagement type, and numlevels can be aggregated together into one record. This may be done to reduce storage requirements.

### Use of Virality Information

Using the viral influence components of FIG. 3, the virality of a resource may be determined. The virality of a resource may then be utilized in a variety of ways.

Influencing User

One use of the virality information is that of determining/finding which user has the biggest influence on a piece of content going viral (patient zero). In this regard, viral influence relates to users making resources/content popular. For any resource, an exemplary system can determine which users had the biggest influence on its usage. For example, if a video has one (1) million plays, a determination can be made regarding which users had the biggest impact on making that happen.

To determine which user has the biggest influence, the following two steps may be performed:

a. For any given user and engagement type, all of a user's engagements for the resource in question that have their viral engagements flag set to true are added together. These are the interactions that other users had with the resource because of the user in question. The sum of these interactions is the total influence the user had on the resource and can be considered their viral points. The viral points on the resource for each user can be compared to all other users that interacted with the resource to determine which users had the largest overall impact in spreading this resource to more users.

b. If there are multiple engagements with a single resource by a user, they can be combined in a formula to show a composite viral points score. For instance, if a user caused one hundred (100) plays of a video and five (5) shares of a video, exemplary embodiments may find it more beneficial to weigh the shares more heavily for purposes of calculating viral points. One formula that may be used is:

TotalPlays*1+TotalShares*50

indicating that a share is fifty (50) times more valuable than a play in terms of viral points.

Biggest Influencers

The virality may also be used to determine the biggest influencers on a social network/site. Once a user's viral points for each resource they have interacted with are known, the viral points can be added together to determine the user's overall viral points. The users with the largest number of viral points are the ones who have the biggest impact to virality on the site because they cause more plays, shares, likes, comments, views, etc. than any other users. Exemplary embodiments recognize that for a variety of reasons, this is a valuable segment of users to identify. Further, such a determination can easily be done in real time. In this regard, by adding up the total number of viral points the user accrued over a window of time, one can determine: (1) the most influential users over the last hour, day, week, month, or any other time frame in real time; and/or (2) the most influential users for any time window in the past that data has been collected for.

Virality in a Reputation Game

A major component of a user's reputation is how others perceive them. One way to measure how one is perceived on a network (e.g., a social network like MySpace™) is to add up the viral points the user has accrued. More viral points mean a better reputation. This can be incorporated into a social game where users are awarded experience points for interacting with the site. Viral points can be the cornerstone of this game, since, in exemplary embodiments, creating or surfacing interesting content on the site and causing other people to interact with such content may be considered highly valuable. To achieve the highest levels in a reputation game, a user will need to have a high number of points. In exemplary embodiments, having a high number of viral points will be the easiest way for a user to achieve a desired reputation.

Advertising

By determining which users are influential on a network, the network host can charge a higher CPM (cost per impression) for advertising to such users because those users have been identified (in real or near real time) as having more influence over other people on the network. Exemplary embodiments of the present invention recognize that most advertisers would want these users to purchase their product because it will increase the respect of their brand via influential people. Also, the ability for measuring user's influence in real time may be integrated with advertising campaign parameters to create a more properly valued budget allocation plan.

In addition, a network host or advertiser can channel content that the host or advertiser wants to become viral through users with a high number of viral points by putting it in front of them.

Curators

A network host can make the people with the highest viral influence, official curators on the network. In exemplary embodiments, these users can be given a special discovery channel where users can find interesting content from these curators, friend/follow them, etc.

Dashboards and Spider Web Charts

A network host can display virality data about a user in a dashboard for them or for other users. One exemplary embodiment displays this data in a spider web chart, where a user's viral influence in various areas is depicted in different corners of the web. For instance, viral points related to photos, videos, and music can be tracked separately. A user can then see how influential they are in each individual area vs. other users on the site.

Badges

Users can be awarded badges for gaining viral points. For example, badges may be awarded for achieving one or more of the following milestones:

a. Being ranked in the 90th percentile among all users in virality;

b. Performing an activity that five (5) other users “like” directly from you;

c. Performing an activity that 25 users “like” any number of levels away from you (e.g., friend of friends who saw your update, etc.); and

d. Achieving a high rank (e.g., 90th percentile+) in virality for two consecutive months.

Accordingly, a variety of different badges may be awarded for achieving different virality ranks, achieving a virality rank over a defined period of time, for being a viral user (and/or causing content to become viral), etc. In this regard, any type of rules may be established for awarding badges as part of an effort to encourage users to interact with a site/resource and to find content/resources that other users will interact with.

Content Promoter

Because the viral influence of all users can be tracked (what songs were played because of them, what videos were shared because of them, etc.), content owners/promoters (e.g., bands) will be able to determine how much specific users are contributing to “spreading the word” about their content. This is similar to how club promoters work—when an individual shows up at the club, the promoter who is responsible for the individual's attendance, receives the credit for such attendance.

The more people show up, the more the club appreciates the promoter, and the more money the promoter (and club) make. Thus, in exemplary embodiments, a network host can give bands, comedians, etc. the ability to provide credit to the appropriate party/user/promoter on a social network by having users promote their songs, videos, etc. Such credit may further provide the ability to compensate such promoters (e.g., monetarily or non-monetarily).

User Influence of Social Network

Based on a user's virality score, top users may be permitted to influence a direction of a network product. For example, a network host can allow the top users on the network, based on their virality ranking, to have a direct line of communication with network development teams. The host can use their suggestions to create a product backlog, which can be broken up vertically or handled all by one team, and then actually implement what users are asking for. In exemplary embodiments, a host can build a process by which users can see that their suggestions are being heard (when a host reads them, responses are generated from the host, etc.) so that users feel like their feedback is being used and that they are being heard.

Taste Makers

Points may be gifted to boost relevance. In exemplary embodiments, users with a large number of viral points can “boost” other content by assigning extra points to it so that the content is ranked higher on network charts, in trending, etc. For example, the higher a user is ranked (social points) the more points such a user may be allowed to give to other content on the site. This can be a channel for taste makers to temporarily increase the relevance and ranking of a band, a video, a song, a profile, or any other content on the site. Users can have a set number of points they can gift every twenty-four (24) hours (rolling) that will recharge over time. In exemplary embodiments, points may not increase beyond a daily maximum for the user.

Award Program

In one or more embodiments, users with a high number of viral points (or users ranking within a certain category of virality or who have achieved a certain milestone) may be awarded benefits. Such benefits may take a variety of forms, from monetary (e.g., cash back), to gift cards, to event tickets (e.g., premier concert ticket opportunities), etc. Such an award program may be similar to a mileage award program offered by airlines or credit card companies that exchange/award/reward customers/users for certain levels of activity. For example, users with a lot of viral points can get better opportunities and may be granted the opportunity to buy or get discounts on tickets to see a band, be allowed to purchase premium seating that is hard to get, meet an artist in person (e.g., backstage passes), etc.

### Overview of Virality Influence

As has been described above, in exemplary embodiments, viral service information advantageously gives users and/or administrators on a network, e.g., a social network, a way to observe how their actions of creating, sharing and interacting with content affect how other users interact with the same content. In such a way, an overall viral influence of a user may be calculated in real time based upon all of the content they have interacted with. Embodiments of the invention also provide insight into how a particular piece of content has been interacted with, e.g., including who interacted with the content, who influenced interaction with the content, and when such interaction occurred. Virality of a piece of content can be tracked for any number of users and up to any number of levels deep.

Thus, aspects of the exemplary viral influence aspects of the present invention can advantageously be used to identify, in real time, which users are the biggest influencers on a site (e.g., finding patient zero). Such information can be used for additional site features, e.g., indicating a reputation of a user, for targeted advertising, for mailings or badges or prizes or giveaways, etc. Such embodiments advantageously overcome the traditional methods requiring expensive data warehouse applications and decreases the time required to obtain this data relative to those warehouse operations. Finally, in aspects where users can see how their actions influence others, users are incentivized in creating and spreading engaging content, which in turn increases the engagement of users to the primary site as a whole (e.g., an entire social network).

Additionally, exemplary embodiments may collect types of data other than viral influence data. In one such exemplary embodiment, data is collected representing how a user interacts with some or all of a network site. In another such exemplary embodiment, data is collected representing how a user, a user's content, or network site resources are interacted with by other users.

### Viral Influence Logical Flow

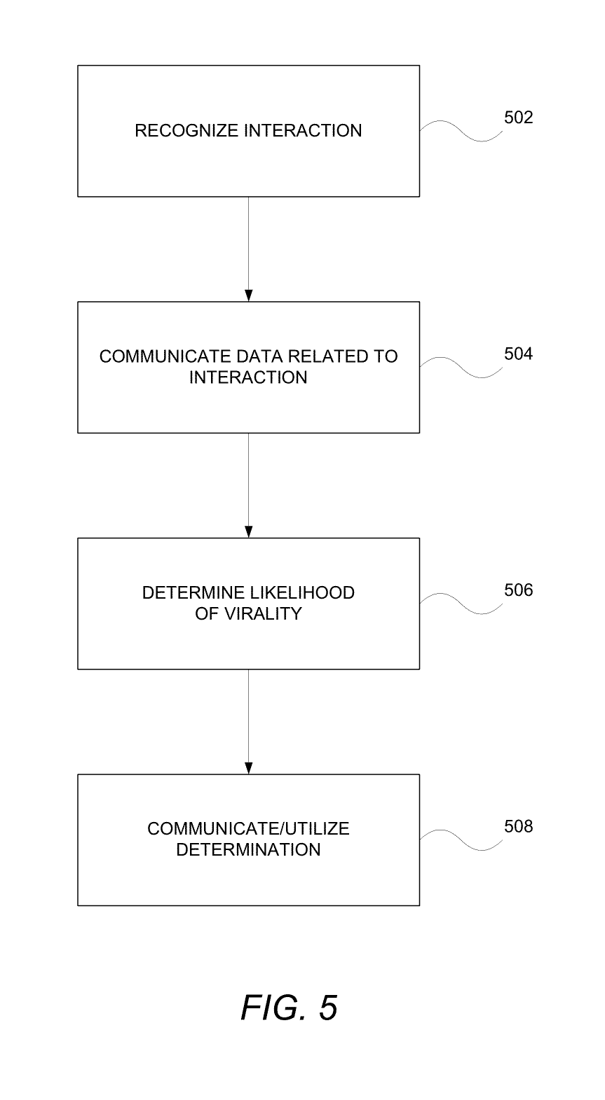

FIG. 5 illustrates the logical flow for tracking user interaction with content in accordance with one or more embodiments of the invention.

At step 502, the interaction with content by a user is recognized. Such interaction may include the sharing of content, the viewing of content, or an indication that the user “likes” the content. Alternatively, the interaction may consist of a user sharing the content to a secondary site (e.g., an audio/video hosting site) followed by linking the content back to a primary site (or by receiving a communication at the primary site that such sharing has occurred).

At step 504, data related to the interaction is communicated, in the form of an engagement message, to a publishing service application. The data in the engagement message includes an identity of the user, an identity of the content interacted with, an engagement type, and an identity of the previous user, if any, who directly influenced the interaction.

At step 506, the publishing service makes a determination regarding the likelihood that the interaction will cause other users to further interact with the content.

At step 508, upon a positive determination at step 506, the determination is communicated to a viral influence application that may perform further processing and/or may utilize the information (e.g., that determines whether users have influence on content relative to other users). For example, the viral influence application may track a history of the interaction with the content by tracking the user identity, the content identity, and the previous user identity. The viral influence application may further generate a list of the previous users that previously interacted with the content. Such a list may indicate how far away a current interaction is relative to interactions of the previous users. Such a list may be sent back to the publishing service application to generate a new engagement message for each of the previous users. The new engagement message identifies the user and content (the same as the first engagement message) as well as the prior user's identity, an indication regarding how far away the current interaction is (relative to the previous user) and a viral engagement indication. Such a viral engagement indication indicates that the user (identified in the new engagement message) did not directly interact with the content but performed some action that indirectly caused the interaction.

The new engagement message may be used by an aggregator service application to aggregate the data in the messages. Such an aggregation may be performed at multiple levels of granularity (e.g., a first level with the content identity and engagement type, and a second level with the user identity, content identity, and engagement type). The aggregator service may further store the aggregated data (e.g., locally) for a predetermined/predefined period of time prior to forwarding the aggregated data to a storage service application.

Step 508 may further include a storage service application that aggregates the data once the data has been stored for a defined/predetermined period of time.

Further to the above, to determine whether users have influence on content relative to other users, the viral influence application may sum all interactions for the content (where the user directly performed the interaction). Such a sum represents a total influence that the user had on the content and may be compared to a corresponding sum of other users (to determine the relative influence). If a given user has interacted multiple times with the same content, each interaction may be weighted based on the engagement type (e.g., a content share, a content view, a content “like”, etc.).

In addition, a score may be assigned to a user with respect to all content that a user has interacted with on a site (e.g., a social network) and compared to other users to determine which user has the larger overall influence on that site. Based on such a score, a level or experience points may be awarded to the user (e.g., as part of a user's “reputation” or as part of a game). Alternatively, awards, recognition, communications access (or priority to a network host, affiliate, or content owner) may be granted to a user based on the user's influence relative to other users. In yet another embodiment, virtual points may be awarded to an influential user. Such virtual points may be temporarily applied by the user to content, thereby boosting a ranking of the content.

Such a score and/or a determination of a user's influence may be used to adjust an advertising cost and/or to channel content. In this regard, content may be channeled to highly influential users in order to increase the popularity/virality of content (e.g., via content owners/promoters). Further, users having influence on content may be identified as content curators such that other users are enabled to discover content via the content curators (e.g., via a channel that is dedicated to that user or by “following” such a user). Lastly, a user interface may be provided to the user that represents the viral influence of the user with respect to different content and with respect to other users (e.g., via a dashboard, chart, graph, etc.).

### Recommendations—A System and Method for Recommending Content

As described herein, example embodiments of the present invention may include methods and systems of recommending content to users by using plural recommendation scoring techniques. Some exemplary techniques compare content to previously consumed content by a user or other users associated with a user. In exemplary embodiments, such comparisons result in content recommendations for which users have a strong affinity. Exemplary processes for discovering relevant content include one or more of content characterization, tagging, relationship scoring and frame scoring, among others.

Exemplary embodiments herein can be configured to provide deeply accurate methods by which users of a content rich system can be introduced to relevant content from other sources, e.g., friends, acquaintances, like-minded users, nearby events, and celebrities, among others. By combining plural techniques of content assessment relative to a user, the expanded set of variables resultant therefrom can be used to greatly improve the accuracy of matches.

In further exemplary embodiments, any of the plural processes may include weighted scores as desired to adjust the likelihood of recommendation. For example, frame scoring may include weighted scores for activities involving users or resources on a site that themselves have higher activity scores. In exemplary embodiments, these users or resources that have higher interactivity with other users or resources may be considered to have a higher frame score. Further, weights may be applied to activities such that more famous users or resources affect the frame scores of other users or resources more than less famous users or resources.

In exemplary embodiments, similar effects can be constructed within, e.g., relationship scoring, where users more tightly affiliated with a particular user affect content recommendation scoring more than other users that are less tightly affiliated with that user.

Further, the relative effectiveness of each of the plural processes can be weighted as desired, e.g., where frame scoring is weighted to affect recommendations more than content characterization.

### Frame Score—A System and Method for Determining User or Resource Influence Within a Pre-Defined Context

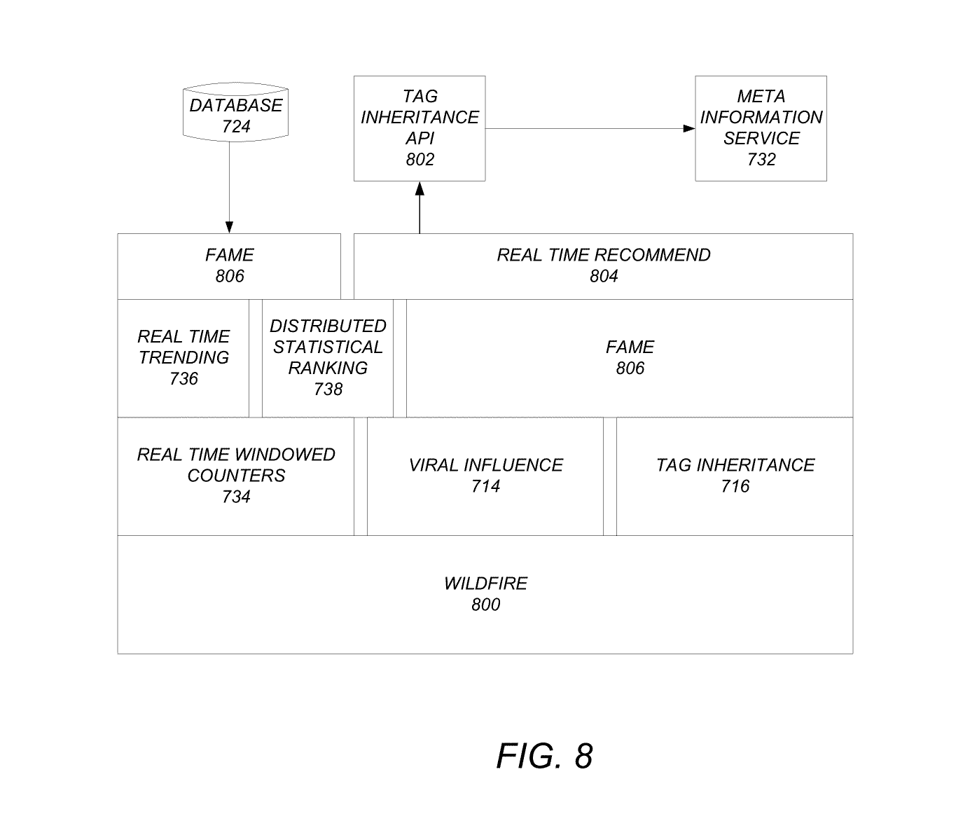

As described herein, example embodiments of the present invention may include systems and methods of determining the influence of a user or resource within a pre-defined context (also referred to as a user's frame [see item 806 of FIG. 8]). In exemplary embodiments, systems and methods described herein assign point values to all activities that may occur within that pre-defined context. In exemplary embodiments, the systems and methods are thus used to determine a user's or resource's global popularity, relevance, and/or desirability based on activities it is or has been associated with.

Thus, exemplary embodiments advantageously provide a uniform scoring mechanism by which any and all activities occurring within a global system can be rated, judged or defined in a mathematical and uniform manner.

In further exemplary embodiments, such determinations may be made over discrete time intervals or in real time across all activities associated with the user or resource. In other exemplary embodiments, such determinations may be made in category specific contexts, including but not limited to a social networking site, point based contests, promotions, games and marketing, among other examples.

In other exemplary embodiments, the systems and methods provide/assign weighted scores to users or resources, such that activities associated with higher scored users or resources affect other users or resources more significantly than lower rated users or resources. Exemplary embodiments also provide awards to higher scored users or resources, for example by way of increased usage opportunity, marketing advantages, feature targeting and higher visibility to the masses, among others.

In another exemplary embodiment, such systems and methods provide a frame score for a user or resource on a social networking site by assigning such point values to all activities on the social networking site. As in other exemplary embodiments, an exemplary weighted scoring may be utilized to allow more famous users or resources to affect the scores of other users or resources more significantly than less famous users or resources, thus rewarding the importance of celebrity influence and organic global reach.

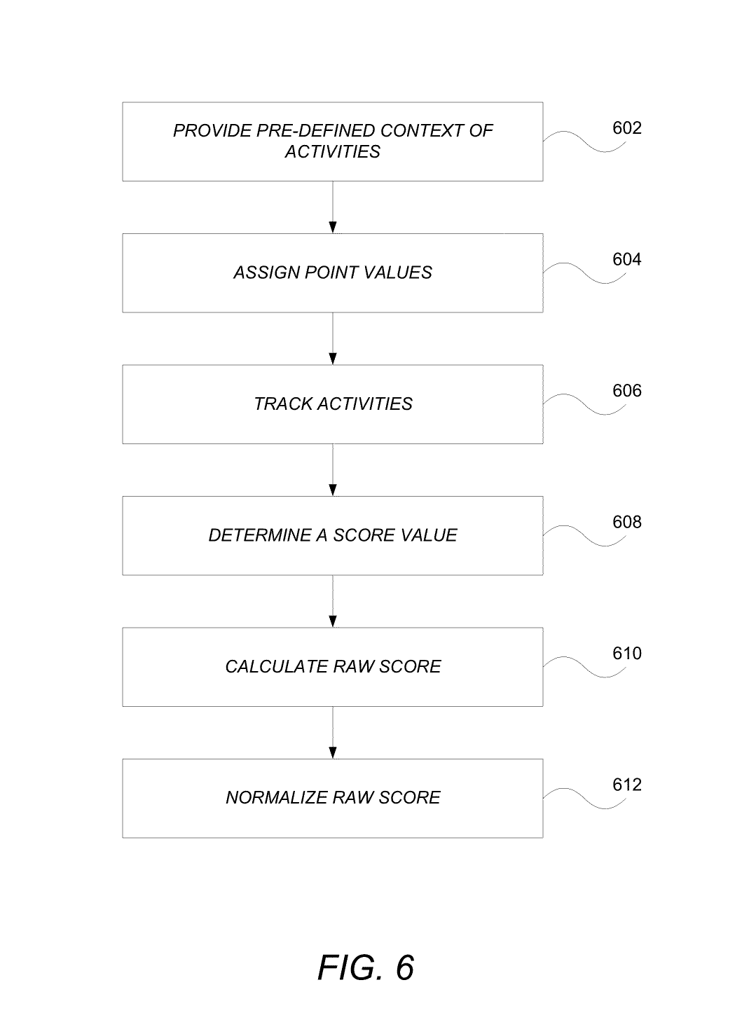

FIG. 6 illustrates an exemplary method of determining the influence of a user or resource within a pre-defined context in accordance with one or more embodiments of the invention.

At step 602, a pre-defined context of activities is provided.

At step 604, point values are assigned to all activities that may occur within that pre-defined context.

At step 606, all activities for a single user or resource within the pre-defined context are tracked over a period of time.

At step 608, a score value for each activity for the single user or resource within the pre-defined context over a period of time is determined.

At step 610, a raw score is calculated for the single user or resource according to the total of all of the determined score values.

At step 612, the raw score value is normalized against scores of a population of other users or resources within the pre-determined context to provide a comparative scoring for users or resources within the pre-defined context.

As used herein, an activity can be defined as any and all interactions that may occur in the pre-defined context. For example, on a network site, such activities can include anything that a user does relative to another person, object, uniquely identifiable resource, etc., or vice versa. Examples of user activities may include clicking through an advertisement, adding a new friend of a social network, expanding a social network, posting real user activities (e.g., status updates, events, etc), uploading and/or sharing multimedia, sharing photos, sharing video, sharing music, or any other suitable activity. Furthermore, user activities may include clicking, accessing, or sharing content already uploaded to the website. For example, a user may access video, music, or any other suitable material posted by a friend or member of a social network, and thus these activities may be tracked. Additionally, a user may click a shared web-link, URL, or other dynamic content previously posted, and thus these activities may also be tracked. Moreover, any other useful or meaningful user activity including new user registration, increasing/decreasing number of friends, web sales, photo deletion, content removal, etc. may also be tracked. It is also noted that the activities described above are only examples of possible activities to be tracked, and should not be construed as limiting.

### System Architecture and Additional Subsystems

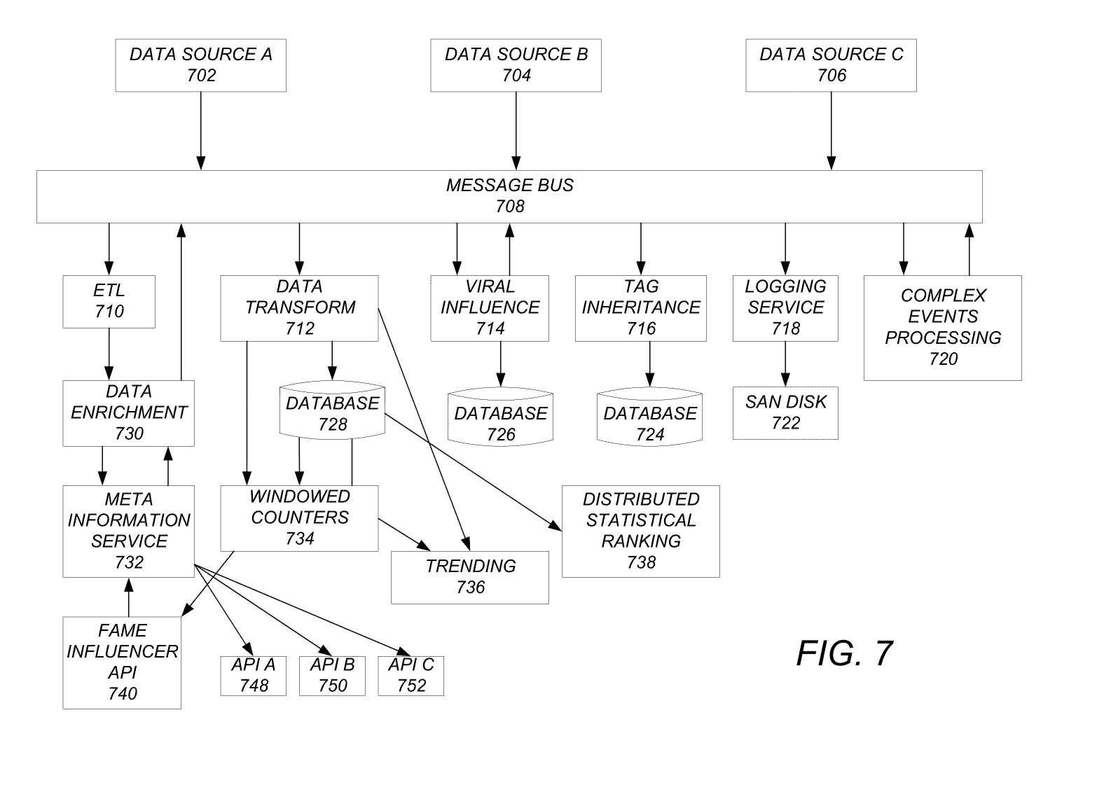

With reference to FIGS. 7 and 8, an exemplary system architecture will be described with reference to and as providing context to various of the above and other subsystems.

The below describes the system architecture in the context of four main systems:

Wildfire Platform

Real-time Data Transform

Real-time Windowed Counters

Real-Time Trending

### Wildfire™ Platform

The Wildfire™ platform (see item 800 in FIG. 8) provides a data pipeline using existing technologies and custom methodologies. One exemplary embodiment uses existing Message Bus 708 (of FIG. 7) technologies to create a stream of rich user-event data. As used herein, the Wildfire™ platform 800 is a social media marketing suite that provides social promotion and advertising software, mobile and desktop page management, messaging, and real-time analytics. Such a platform 800 may communicate with various subsystems to provide data and information that can be utilized in a social media network. Basic exemplary functions of the platform 800 and relevant subsystems are described immediately below:

In exemplary embodiments, the platform 800 performs one or more of the following: receives live streaming data from multiple data sources, such as data sources A, B, and C in FIG. 7 (items 702, 704 and 706, respectively) (e.g., via message bus 708); normalizes data into a common format via extraction, transformation and loading (ETL) functions 710, and enriches data 730 with meta information 732 (e.g., see FIGS. 7 and 8) from numerous internal systems, for example Frame/Influencer API 740 (and frame subsystem 806) and Tag Inheritance API (802) (and Tag Inheritance 716). Accordingly, the meta information service 732 communicates with APIs A, B and C (748, 750 and 752 respectively in FIG. 7) to enrich the data 730 with appropriate met information.

In exemplary embodiments, the data enrichment process 730 may further maintain state between various events as part of data enrichment, which adds the ability for information from one data source to be applied to others. Additionally, business rules may be applied to detect “gaming”, which is a process whereby an individual or algorithm maliciously targets a resource in order to improve their score or rank in a chart. Enriched data may also be transformed and multi-casted according to business rules to raise parent events. An example follows: A user plays a Song, and the system transforms that song play into an Album play and creates a secondary engagement.

The exemplary platform may also manage data durability. Conceptually, this is the process of ensuring that no data is lost and a history of actions are kept, e.g., by logging service 718 and associated San Disk 722, as well as via complex events processing 720. In such a way, data is also ensured to be delivered in order.

The exemplary platform may also be configured such that subscribers can consume data through a common stream source (e.g., by consuming data and republishing the data [for consumption by any subscriber] between the viral influence functionality 714 [and related database 726] and the message bus 708). In exemplary embodiments, each consumer may maintain their own bookmark or placeholder.

Further, consumers can request historical data from a “durable data buffer” within the message bus 708. Thus, new consumers will be able to start off from historical data. If a consumer encounters an error or goes offline, they can recover and retrieve data from where they left off (e.g., by accessing information maintained by logging service 718 and complex events processing 720). Further, when historical data has been processed, consumers can automatically switch over to a live stream.

### Real-Time Data Transform

Real-time data transform 712 provides an exemplary system that transforms and multicasts streamed data based on all of the data's meta information and a series of configurations. The configurations map the attributes of the incoming data to any combination of transformed Keys. Examples of datapoints include: Music Genre; IP Location (city, country); Meta Tag; and UserId, among others.

Filters can be applied to any data point, and each attribute can also be filtered using one or more of: Explicit list of values; Regular expression; and Lambda expression. Each filter can be inclusive or exclusive (e.g.: only things in this list; or none of these things in this list).

Data can be streamed through the transform 712—this means there is no delay and the data is transformed in real time, and transformed data can be aggregated and or streamed in real time, depending on required use cases.

A weight may also be applied to the transformed data based on the configuration. In exemplary embodiments, each configuration can have its own weight, and weight can be dynamically adjusted based on the context of the event. For example, the weight for a French music chart by someone who lives in France will differ from someone who lives in a neighboring country versus someone who lives on a difference continent. In another example, the weight for a song play by someone famous will be different than for someone who is not famous.

As was described above, the data transform 712 transforms and aggregates data from message bus 708. It should be recognized that as used herein, “real time” refers to relatively fast transforms and communications. This may be, e.g., on the order of seconds or minutes. Also, the rate of communication may vary for different communications. For example, data transform 712 may communicate with database 728 every minute, while communicating with windowed counters 734 every second. Finally, in all cases herein, use of “real time” is strictly optional, and should not be construed to limit the invention described herein.

### Real-Time Windowed Counters

Real-time windowed counters 734 relate to an exemplary method for storing incremented counts for anything over a sliding window of time. This exemplary method utilizes a unique technique, where the performance of a small window does not differ at all from a very large window. An exemplary physical implementation utilizes an existing cache technology to store the values, but it can be implemented on any system.

In an exemplary method, the following parameters are defined: Entity Identifier of what is being counted; Window Size (e.g., 1-week); and Datapoint Size (e.g., 1-hour). The following values may be maintained in cache: A Linked-List (or a stack) may be used to store the historical sequence of data points; a “real-time” counter is used to store the current datapoint; a running total is maintained which is the logical sum of everything in the linked-list/stack; a “last updated” date is stored. In exemplary embodiments, when the counter is incremented, the “real-time” counter is incremented. Further, when the current time minus the “last updated” value becomes greater than the DatapointSize, the “real time” value is pushed into the LinkedList/stack and the logical maximum of items in the linked list/stack is WindowSize/DatapointSize. If the size of the list/stack exceeds this maximum, then the oldest value is popped off. The value of the popped record is subtracted from the running total.

Further in the exemplary embodiment, when a count is requested, the system returns the running total of the linked list plus the “real-time” counter value. When a count is requested, or a count is incremented, the LastUpdate value is checked. If the lastUpdate exceeds the DatapointSize by more than one, the correct number of zeros is pushed onto the Linked List and the same logic as above is performed. This action ensures that the counter's windowing is always applied even if the counter hasn't been accessed for a period of time. The data points stored in the Linked List act as a list of deltas, which can also be used to plot a graph over time of that counter's data change.

### Real-Time Trending

Trending 736 is an exemplary system that builds charts of trending and popular resources. In exemplary embodiments, trending (or optionally real-time trending) utilizes two systems: Real-time Data Transform 712 and Real-time Windowed Counters 734. Data is streamed through the Transform 712 to create chart keys. The Chart Key+Resource Identifier are used to create Windowed Counters 734 using the Real-Time Windowed Counters infrastructure. Window Size is determined by the Chart Definition, and Multiple window sizes can be specified.

When a resource for a chart is incremented, the resulted total is compared against a threshold for that chart. If the value is less than the threshold, then no action is taken. If the value is greater or equal to the threshold, then the resource is added to a list of “Chart Candidates.”

The threshold is determined by: the smallest value in the existing chart; and the “fullness” of the chart. The Chart Definition determines the interval at which the chart will be published. When publishing, the current counter value for each resource in the Candidate list are retrieved. The list is ordered by the values. The Top X (as determined by the Chart Definition) are taken from the list of Candidates. The list of candidates is replaced by the new chart so that this list is always primed with the contents of the last chart. Then, the new Threshold is calculated, and chart subscribers are notified that there is a new chart available (update cached values).

In other exemplary embodiments, a b-tree may be used to store data in such a way that all resources on a site can have an absolute ranking

The following are various exemplary types of charts. Top Fans is a chart that is derived from the top consumers/fans of a specific resource. Famous/Influential is a chart that is derived from resources that are consumed the most. This can be any object, most notably people/groups of users of a system. Popular is a basic chart based on totals over the defined window. The totals can be sorted and ranked. Trending 736 is a type of chart that utilizes the historical data points to calculate velocity/trajectory. Types of exemplary formulas include regression projection/sum of squares and historical decay based on age of resource and time/position in charts, among others. Recency is similar to the Popular chart but utilizes a filter on the Transform 712 to only include content that has recently been published.

Locality is another type of chart that utilizes a dynamic weight in the Transform 712 to adjust the value of a song play for each country/region. For example, song plays from anywhere in the world will all count toward the French Music Chart. This ensures that each country will have a full music chart available to them, even if the product is not popular in that country. Plays from that country will have a 100% weight. Plays from neighboring countries will have a 50% weight. Plays from the rest of the world will have a 5% weight. Songs which gain traction in that country will very quickly rise to the top of the chart. Popular songs from other parts of the world will still make up the rest of the chart, ensuring a rich set of data. As a side note, a resources ranking/score in a chart can be used as a Dynamic Weighting input to the Real Time Data Transform.

### Tag Inheritance

Inheritance 716, related database 724 and Tag Inheritance API 802 (from FIG. 8) is an exemplary process of implicitly identifying/altering affinities for resources and users in real time via the collection of stream data. This is accomplished through analyzing the behavior of users in a system. One exemplary purpose of this technology is to power and improve the system's recommendation 804 and affinity systems.

Inheritance Methodology

A key exemplary concept of an inheritance methodology is that users and resources inherit affinities from one another as interactions occur. The basic premise of this concept is that there is a reason why a user interacts with a resource (song, video, etc.), which ultimately indicates that there are things in common between the two. Affinities are represented as tags in this system. The following examples illustrate the concept:

### Example 1

1. User A has no tags

2. Song 1 has the following genre tags:
a. Rock: 70% affinity
b. Country: 30% affinity

3. User A plays Song 1

4. User A inherits the following tags:
a. Rock: 70% affinity
b. Country: 30% affinity

### Example 2

1. User A has the following tags
a. Rock: 70% affinity
b. Country: 30% affinity

2. Song 2 has the following genre tags:
a. Soul: 60% affinity
b. Hip Hop: 40% affinity

3. User A plays Song 2

4. User A inherits tags from Song 2 and has the following tags:
a. Rock: 35% affinity
b. Country: 15% affinity
c. Soul: 30% affinity
d. Hip Hop: 20% affinity

5. Song 2 inherits from User A and has the following tags:
a. Rock: 35% affinity
b. Country: 15% affinity
c. Soul: 30% affinity
d. Hip Hop: 20% affinity

### Example 3

1. User A has the following tags
a. Rock: 35% affinity
b. Country: 15% affinity
c. Soul: 30% affinity
d. Hip Hop: 20% affinity

2. Song 3 has no tags

3. User A plays Song 3

4. Song 3 inherits from User A and has the following tags:
a. Rock: 35% affinity
b. Country: 15% affinity
c. Soul: 30% affinity
d. Hip Hop: 20% affinity

The amount one resource inherits from another may be determined by strength of the tag, which is the percentage. That percentage is converted to a raw score to be used in the calculation of the new percentages for each respective resource.

For example:

1. User A has the following Tag:
a. Rock: 70%—Raw Score: 0.7
b. Country: 30%—Raw Score: 0.3
c. Total Raw Score total: 1.00

2. Song 1 has the following Tag:
a. Soul: 60% affinity
b. Hip Hop: 40% affinity
c. Total Raw Score total: 1.00

3. User A plays Song 1

4. Updates to User A
a. Raw Score increases by 1.00 (0.6 from Soul & 0.4 from Hip Hop)
b. New Raw Score total: 2.00
c. Rock: 35%=(0.7/2.00)*100
d. Country: 15%=(0.3/2.00)*100
e. Soul: 30%=(0.6/2.00)*100
f. Hip Hop: 20%=(0.4/2.00)*100

5. Updates to Song 1—Same formula as above

In exemplary embodiments, a resource can only pass on a tag to another resource if it has inheritance occurrence count of X. That X is a configured value and the purpose of this logic is to minimize the exacerbation of user choices that are not representative or their preferences. The amount inherited per tag may decay proportionately in percentage from the inheritance distance level of the originally seeded tag.

The above examples use genre as the tag type, but the system is designed to handle any number of Tag Types. For example: Locations, Age, Gender and User to User, among others. Exemplary uses for this include, but are not limited to song recommendations (e.g., in Radio Mode) and event recommendations.

### Influence Score

Influence provides an exemplary method of identifying influential users in social media. In exemplary embodiments, the method provides a measure of actions and reactions to those actions. Reactions to actions increase influence score. Reactions are also actions that may cause additional reactions. In providing an exemplary calculation, the following variables apply: n=Upper bound of actions to include in a sliding window, by epoch time; m=Lower bound of actions to include in a sliding window, by epoch time; p=Person who performed action; a=Base score for the action; l=Number of levels away the user was from the action; and t=Epoch time the action took place.

The following functions may then be defined: d(t)=Returns a number from 0 . . . 1 indicating how much time decay to apply; w(p,a)=Returns a score for a user performing an action; s(p)=Influence score for a person; and k(a, 1)=Returns the modified base score for an action based on how far away it occurred from the user (used to support viral actions).

The following exemplary formulas can then be utilized: s(p)=Σw(p,a(l))*d(t); w(p,a)=log(s(p))*a; d(t)=(t−m)/(n−m); and k(a,l)=a*1/l.

Variations also follow. For example, the formula specified for time decay is linear for simplicity, but any decay formula can be substituted here such as logistic, exponential, cubic, etc. Also, the formula for modified base scores reduces the base score by half for each additional level away that the action occurred. This rate of decay can be adjusted either up or down to provide more or less influence using any available decay formula. Additionally, the formula for base weight uses log base 10, but this base can be adjusted to provide more or less weight to users with high influence scores performing actions. The setting for this may be chosen based on the distribution of influence scores across all people.

The following examples illustrate the application:

### Example 1

1. User A's influence score is 50

2. User B's influence score is 10

3. The base weight for a song play is 5 points

4. t=n (this is being measured in real time so the time decay function returns 1, causing it to not be a factor)

5. User A plays Song 1, which is owned by User B

6. User B gets points:
a. Since the action occurred directly (1 level away), the play is worth the full 5 points
b. User B gains log(50)*5 points. Log(50) base 10=1.7, and 1.7*5=8.5 points
   This will decay over time as the action becomes older relative to the sliding time window

7. User B's influence score is now 18.5

### Example 2

### Viral

1. User C's influence score is 90

2. User C plays Song 1 because they saw that User A played it

3. User A gets points:
a. Since the action occurred directly (1 level away), the play is worth the full 5 points
b. User A gains log(90)*5 points. Log(90) base 10=1.95*5=9.8 points

4. User A's influence score is now 59.8

5. User B gets points:
a. Since user B influences A to play the song, this action affects them as well, but two levels away. This distance modifies the base weight of the song to be 5*½=2.5 points
b. User B gains log(59.8)*2.5 points. Log(59.8) base 10=3.89*2.5=4.4 points

6. User B's influence score is 18.5+4.4=22.9

### Hardware Environment

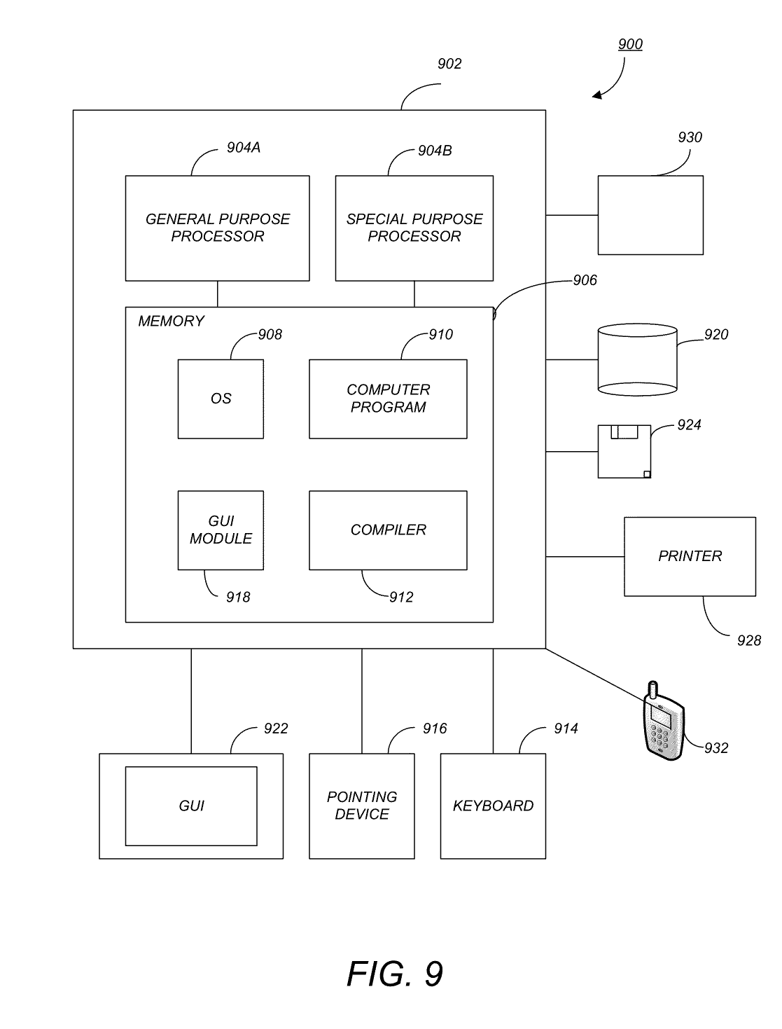

FIG. 9 is an exemplary hardware and software environment 900 used to implement one or more embodiments of the invention. The hardware and software environment includes a computer 902 and may include peripherals. Computer 902 may be a user/client computer, server computer, or may be a database computer. The computer 902 comprises a general purpose hardware processor 904A and/or a special purpose hardware processor 904B (hereinafter alternatively collectively referred to as processor 904) and a memory 906, such as random access memory (RAM). The computer 902 may be coupled to, and/or integrated with, other devices, including input/output (I/O) devices such as a keyboard 914, a cursor control device 916 (e.g., a mouse, a pointing device, pen and tablet, touch screen, multi-touch device, etc.) and a printer 928. In one or more embodiments, computer 902 may be coupled to, or may comprise, a portable or media viewing/listening device 932 (e.g., an MP3 player, iPod™, Nook™, portable digital video player, cellular device, personal digital assistant, etc.). In yet another embodiment, the computer 902 may comprise a multi-touch device, mobile phone, gaming system, internet enabled television, television set top box, or other internet enabled device executing on various platforms and operating systems.

In one embodiment, the computer 902 operates by the general purpose processor 904A performing instructions defined by the computer program 910 under control of an operating system 908. The computer program 910 and/or the operating system 908 may be stored in the memory 906 and may interface with the user and/or other devices to accept input and commands and, based on such input and commands and the instructions defined by the computer program 910 and operating system 908, to provide output and results.

Output/results may be presented on the display 922 or provided to another device for presentation or further processing or action. In one embodiment, the display 922 comprises a liquid crystal display (LCD) having a plurality of separately addressable liquid crystals. Alternatively, the display 922 may comprise a light emitting diode (LED) display having clusters of red, green and blue diodes driven together to form full-color pixels. Each liquid crystal or pixel of the display 922 changes to an opaque or translucent state to form a part of the image on the display in response to the data or information generated by the processor 904 from the application of the instructions of the computer program 910 and/or operating system 908 to the input and commands. The image may be provided through a graphical user interface (GUI) module 918. Although the GUI module 918 is depicted as a separate module, the instructions performing the GUI functions can be resident or distributed in the operating system 908, the computer program 910, or implemented with special purpose memory and processors.

In one or more embodiments, the display 922 is integrated with/into the computer 902 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 902 according to the computer program 910 instructions may be implemented in a special purpose processor 904B. In this embodiment, the some or all of the computer program 910 instructions may be implemented via firmware instructions stored in a read only memory (ROM), a programmable read only memory (PROM) or flash memory within the special purpose processor 904B or in memory 906. The special purpose processor 904B may also be hardwired through circuit design to perform some or all of the operations to implement the present invention. Further, the special purpose processor 904B may be a hybrid processor, which includes dedicated circuitry for performing a subset of functions, and other circuits for performing more general functions such as responding to computer program 910 instructions. In one embodiment, the special purpose processor 904B is an application specific integrated circuit (ASIC).

The computer 902 may also implement a compiler 912 that allows an application or computer program 910 written in a programming language such as COBOL, Pascal, C++, FORTRAN, or other language to be translated into processor 904 readable code. Alternatively, the compiler 912 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 910 accesses and manipulates data accepted from I/O devices and stored in the memory 906 of the computer 902 using the relationships and logic that were generated using the compiler 912.

The computer 902 also optionally comprises an external communication device such as a modem, satellite link, Ethernet card, or other device for accepting input from, and providing output to, other computers 902.

In one embodiment, instructions implementing the operating system 908, the computer program 910, and the compiler 912 are tangibly embodied in a non-transient computer-readable medium, e.g., data storage device 920, which could include one or more fixed or removable data storage devices, such as a zip drive, floppy disc drive 924, hard drive, CD-ROM drive, tape drive, etc. Further, the operating system 908 and the computer program 910 are comprised of computer program 910 instructions which, when accessed, read and executed by the computer 902, cause the computer 902 to perform the steps necessary to implement and/or use the present invention or to load the program of instructions into a memory 906, thus creating a special purpose data structure causing the computer 902 to operate as a specially programmed computer executing the method steps described herein. Computer program 910 and/or operating instructions may also be tangibly embodied in memory 906 and/or data communications devices 930, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 902.

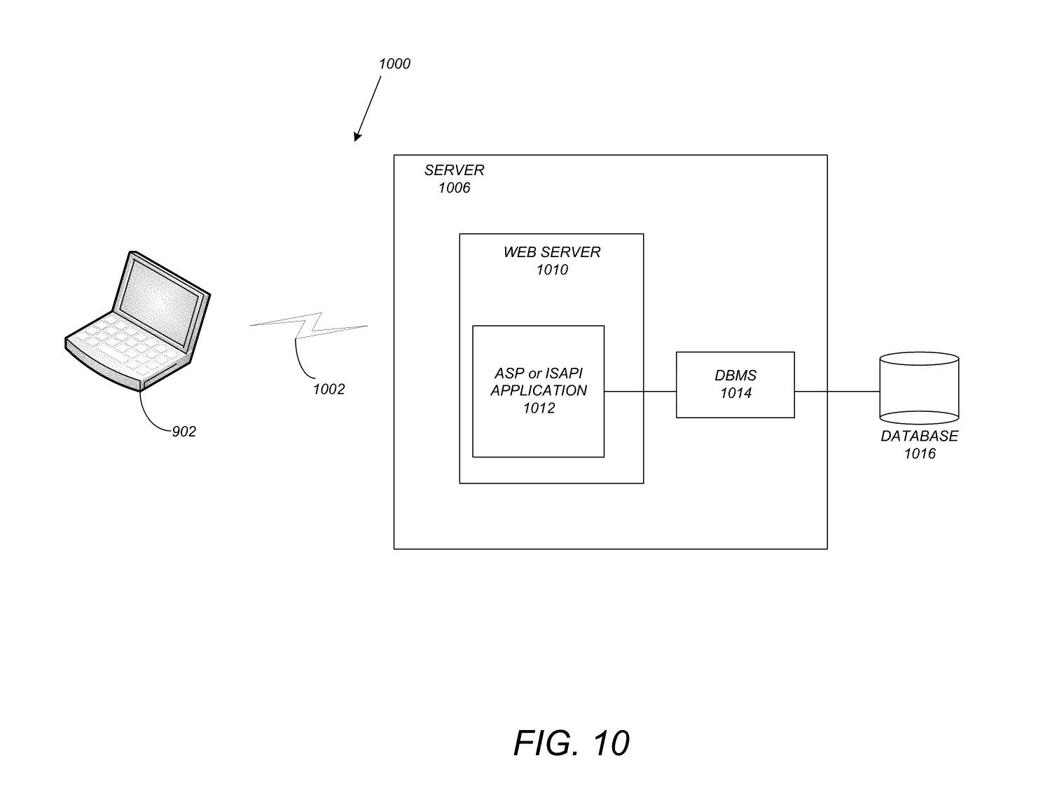

FIG. 10 schematically illustrates a typical distributed computer system 1000 using a network 1004 to connect client computers 902 to server computers 1006. A typical combination of resources may include a network 1004 comprising the Internet, LANs (local area networks), WANs (wide area networks), SNA (systems network architecture) networks, or the like, clients 202 that are personal computers or workstations (as set forth in FIG. 9), and servers 1006 that are personal computers, workstations, minicomputers, or mainframes (as set forth in FIG. 9). However, it may be noted that different networks such as a cellular network (e.g., GSM [global system for mobile communications] or otherwise), a satellite based network, or any other type of network may be used to connect clients 902 and servers 1006 in accordance with embodiments of the invention.

A network 1004 such as the Internet connects clients 902 to server computers 1006. Network 1004 may utilize ethernet, coaxial cable, wireless communications, radio frequency (RF), etc. to connect and provide the communication between clients 902 and servers 1006. Clients 902 may execute a client application or web browser and communicate with server computers 1006 executing web servers 1010. Such a web browser is typically a program such as MICROSOFT INTERNET EXPLORER™, MOZILLA FIREFOX™ OPERA™, APPLE SAFARI™, GOOGLE CHROMEe, etc. Further, the software executing on clients 902 may be downloaded from server computer 1006 to client computers 902 and installed as a plug-in or ACTIVEX™ control of a web browser. Accordingly, clients 902 may utilize ACTIVEX™ components/component object model (COM) or distributed COM (DCOM) components to provide a user interface on a display of client 902. The web server 1010 is typically a program such as MICROSOFT'S INTERNET INFORMATION SERVER™.

Web server 1010 may host an Active Server Page (ASP) or Internet Server Application Programming Interface (ISAPI) application 1012, which may be executing scripts. The scripts invoke objects that execute business logic (referred to as business objects). The business objects then manipulate data in database 1016 through a database management system (DBMS) 1014. Alternatively, database 1016 may be part of, or connected directly to, client 902 instead of communicating/obtaining the information from database 1016 across network 1004. When a developer encapsulates the business functionality into objects, the system may be referred to as a component object model (COM) system. Accordingly, the scripts executing on web server 1010 (and/or application 1012) invoke COM objects that implement the business logic. Further, server 1006 may utilize MICROSOFT'S™ Transaction Server (MTS) to access required data stored in database 1016 via an interface such as ADO (Active Data Objects), OLE DB (Object Linking and Embedding DataBase), or ODBC (Open DataBase Connectivity).

Generally, these components 1000-1016 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 902 and 1006 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 902 and 1006.

### Software Embodiment Overview

Embodiments of the invention are implemented as a software application on a client 902 or server computer 1006. Further, as described above, the client 902 or server computer 1006 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 902, portable device, etc.

As described above, client 902 or server computer 1006 may integrate and provide the capabilities described in FIGS. 1-8. In this regard, the platform and processing capabilities that provide the ability to present and manage social media may be performed by client 902, server 1006, and/or a combination of client 902 and/or server 1006.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for presenting media content on a social media network comprising:
receiving, in a computer, live streaming data from multiple data sources;
enriching the live streaming data with meta information using one or more internal systems via application programming interfaces (APIs) for the one or more internal systems; and
transforming and transmitting the live streamed data based on the meta information, wherein the transformed live streamed data is transmitted to one or more users on a social media network.

2. The computer-implemented method of claim 1, further comprising:
normalizing the live streaming data into a common format via extraction transformation, and loading functions.

3. The computer-implemented method of claim 1, wherein one of the one or more internal systems comprises a frame application that identifies an influence of a user or resource within a pre-defined context based on point values assigned to activities that occur within the pre-defined context.

4. The computer-implemented method of claim 1, wherein one of the one or more internal systems comprises a tag inheritance system that determines affinities for resources and users via the live streamed data.

5. The computer-implemented method of claim 1, wherein the enriching comprises:
maintaining state between one or more events such that meta information from one of the one or more internal systems is applied to a second of the one or more internal systems.

6. The computer-implemented method of claim 1, further comprising ensuring that the live streaming data is not lost by:
maintaining a history of actions using a logging service and complex events processing.

7. The computer-implemented method of claim 1, wherein the transforming is based on a series of one or more configurations that map an attribute of the live streaming data to a combination of one or more transformed keys.

8. The computer-implemented method of claim 7, wherein:
each configuration comprises a weight;
the weight is applied to the transformed data; and
the weight is dynamically adjusted based on a context of an event associated with the live streamed data.

9. The computer-implemented method of claim 1, wherein the transforming comprises:
utilizing a real-time windowed counter that stores incremented counts over a sliding window of time.

10. The computer-implemented method of claim 9, further comprising:
determining elements of the live streaming data that are trending based on the real-time windowed counter.

11. A system for presenting media content on a social media network comprising:
live streaming data received from multiple data sources into a computer;
one or more internal systems, executing in the computer, that enrich the live streaming data with meta information via application programming interfaces (APIs) for the one or more internal systems; and
a data transform, executing in the computer, that transforms and transmits the live streamed data based on the meta information, wherein the transformed live streamed data is transmitted to one or more users on a social media network.

12. The system of claim 11, further comprising:
an extraction, transformation, and loading (ETL) module, executing in the computer, that normalizes the live streaming data into a common format.

13. The system of claim 11, wherein one of the one or more internal systems comprises a frame application that identifies an influence of a user or resource within a pre-defined context based on point values assigned to activities that occur within the pre-defined context.

14. The system of claim 11, wherein one of the one or more internal systems comprises a tag inheritance system that determines affinities for resources and users via the live streamed data.

15. The system of claim 11, wherein one or more of the internal systems is configured to enrich the data by:
maintaining state between one or more events such that meta information from one of the one or more internal systems is applied to a second of the one or more internal systems.

16. The system of claim 11, further comprising a logging service and complex events processing executing in the computer, wherein the logging service and complex event processing ensure that the live streaming data is not lost by maintaining a history of actions.

17. The system of claim 11, wherein the transforming is based on a series of one or more configurations that map an attribute of the live streaming data to a combination of one or more transformed keys.

18. The system of claim 17, wherein:
each configuration comprises a weight;
the weight is applied to the transformed data; and
the weight is dynamically adjusted based on a context of an event associated with the live streamed data.

19. The system of claim 11, wherein the one or more internal systems is configured to transform the live streamed data by utilizing a real-time windowed counter that stores incremented counts over a sliding window of time.

20. The system of claim 19, wherein one of the one or more internal systems comprises a trending application configured to determine elements of the live streaming data that are trending based on the real-time windowed counter.
